(19) United States
(12) Patent Application Publication
(10) Pub. No.: US 2016/0004408 A1
(43) Pub. Date: Jan. 7, 2016

(54) METHODS, SYSTEMS AND RECORDING MEDIUMS FOR IMPROVING MOBILE DEVICES USING USER GESTURES

(71) Applicant: NAVER CORPORATION, Seongnam-si (KR)

(72) Inventor: Chan Ho YUN, Seongnam-si (KR)

(21) Appl. No.: 14/755,365

(22) Filed: Jun. 30, 2015

(30) Foreign Application Priority Data
Jul. 1, 2014 (KR) 10-2014-0081977
Jan. 16, 2015 (KR) 10-2015-0007945

(51) Int. Cl. G06F 3/0488; G06F 3/01

(52) U.S. Cl. CPC G06F 3/0488; G06F 3/017

(57) ABSTRACT

Methods, systems, and non-transitory computer-readable mediums for improving operation of a mobile device using a user gesture are provided. A method includes detecting, by a processor, a gesture on a mobile device using a gesture recognition device of the mobile device, and performing, by the processor, an improvement operation associated with at least one of a memory and a battery of the mobile device in response to the detected gesture.

### CROSS-REFERENCE TO RELATED APPLICATION

This application claims priority under 35 U.S.C. §119 to Korean Patent Application No. 10-2014-0081977, filed on Jul. 1, 2014, and Korean Patent Application No. 10-2015-0007945, filed on Jan. 16, 2015, the disclosure of which is incorporated herein its entirety by reference.

### BACKGROUND

1. Field

Example embodiments relate to technology for improving and/or optimizing performance of mobile devices.

2. Description of the Related Art

Users using mobile devices experience various inconveniences associated with speed, battery, and storage space, such as latency issues, insufficient battery capacity, degradation in battery performance over time, lack of storage space, etc.

To help users more efficiently manage mobile devices, recent mobile devices provide, for example, functions for displaying battery temperature, remaining battery amount, remaining battery time, deleting cache or remaining files and/or deleting undesired applications.

However, due to a complexity of using methods or menu configurations of the mobile devices, users may experience difficulties in finding desired functions based on a state of a mobile device. These difficulties make the users' experience inconvenient when managing mobile devices.

### SUMMARY

At least some example embodiments provide methods, systems, and/or non-transitory computer-readable mediums that may provide an environment that allows for a more convenient and/or easy user access.

At least some example embodiments provide methods, systems, and/or non-transitory computer-readable mediums capable of improving and/or optimizing a mobile device using a relatively simple and/or intuitive gesture.

At least some example embodiments provide methods, systems, and/or non-transitory computer-readable mediums that may improve and/or optimize a mobile device with relative ease and speed, without using a complex path or inconvenient setting.

According to an example embodiment, a method for operating a mobile device includes: detecting, by a processor, a gesture on the mobile device using a gesture recognition device of the mobile device; and performing, by the processor, an improvement operation associated with at least one of a memory and a battery of the mobile device in response to the detected gesture.

The detecting may include detecting the gesture based on one of a touch operation and a motion defined by a user command that requests improvement of the mobile device.

The detecting may include, as the user command requesting the improvement operation, detecting one of a turnover gesture that turns over the mobile device, a swipe gesture that swipes a screen of the mobile device, and a shake gesture that shakes the mobile device.

The improvement operation may include at least one of (i) a function of deleting at least one of an inactive task and a background task from the memory, (ii) a function of deleting at least one of a cache file, a temporary file, and an application unused for at least a threshold period from the memory, and (iii) a function of performing a power saving mode of the battery. A common gesture may be defined for all functions included in the improvement operation or a different gesture may be defined for each individual function.

The performing may include deleting at least one of an inactive task and a background task from the memory in response to the detected gesture.

The performing may include deleting, from the memory in response to the detected gesture, at least one of a cache file, a temporary file, an application unused for at least a threshold period, content unused for at least the threshold period, and a file having a size greater than a threshold size.

The performing may include performing a power saving mode of the battery in response to the detected gesture.

In the power saving mode, at least one of a communication module, a background application, screen brightness, an automatic synchronization, and haptic feedback of the mobile device may be limited.

The performing may include performing the improvement operation stage by stage in response to repeated detection of the gesture, and the optimization operation may include a plurality of stages.

The performing may include skipping a middle stage of the improvement operation and performing a final stage of the improvement operation in response to a level of the detected gesture being greater than or equal to a threshold level.

According to an example embodiment, there is provided a non-transitory computer-readable medium including computer-readable instructions that, when executed by a processor, cause the processor to perform a method comprising: detecting a gesture on a mobile device using a gesture recognition device of the mobile device; and performing an improvement operation associated with at least one of a memory and a battery of the mobile device in response to the detected gesture.

According to an example embodiment, a system may include a processor and a memory. The processor may include a detector configured to detect a gesture on a mobile device using a gesture recognition device of the mobile device, and an optimizer configured to perform an improvement operation associated with at least one of a memory and a battery of the mobile device in response to the detected gesture.

The detector may be further configured to detect, as the user command requesting the improvement operation, one of (i) a turnover gesture that turns over the mobile device, (ii) a swipe gesture that swipes a screen of the mobile device, and (iii) a shake gesture that shakes the mobile device.

The improvement operation may include at least one of (i) deleting at least one of an inactive task and a background task from the memory, (ii) deleting at least one of a cache file, a temporary file, and an application unused for at least a threshold period from the memory, and (iii) performing a power saving mode of the battery. A common gesture may be defined for functions included in the improvement operation or a different gesture may be defined for each individual function.

The optimizer may be configured to delete at least one of an inactive task and a background task from the memory in response to the detected gesture.

The optimizer may be configured to delete, from the memory in response to the detected gesture, at least one of a cache file, a temporary file, an application unused for at least a threshold period, content unused for at least the threshold period, and a file having a size greater than a threshold size.

The optimizer may be configured to perform a power saving mode of the battery in response to the detected gesture.

In the power saving mode, at least one of a communication module, a background application, screen brightness, an automatic synchronization, and haptic feedback of the mobile device may be limited.

When the improvement operation includes a plurality of stages, the optimizer may be configured to perform the improvement operation stage by stage in response to repeated detection of the gesture.

The optimizer may be configured to skip a middle stage of the improvement operation and perform a final stage of the improvement operation in response to a level of the detected gesture being greater than or equal to a threshold level.

It is to be understood that both the foregoing general description and the following detailed description are explanatory and are intended to provide further explanation of the example embodiments as claimed.

According to at least one example embodiment, a user may automatically access an optimization environment using a simple and intuitive gesture and thus, may manage a mobile device with relative ease and convenience.

Also, according to at least one example embodiment, since it is possible to maintain a mobile device in an optimal state substantially at all times by automatically optimizing the mobile device in response to a user gesture, thereby enhancing performance of the mobile device.

Also, according to at least one example embodiment, because a user may achieve optimization (e.g., a memory cleaning, a battery management and/or an application management) using a simple gesture, a user convenience may be provided. By contrast, in a conventional technology, users have to search his or her own the mobile device for appropriate optimization function(s) or application(s) and path(s) arriving thereat and directly execute an application,

### BRIEF DESCRIPTION OF THE DRAWINGS

The foregoing and other features of the example embodiments will be apparent from the more particular description of non-limiting example embodiments, as illustrated in the accompanying drawings in which like reference characters refer to like parts throughout the drawings. The drawings are not necessarily to scale, emphasis instead being merely provided so that this disclosure will fully convey the scope of the inventive concepts to those skilled in the art. In the drawings:

FIG. 1 is a diagram illustrating a relationship between a user terminal and an optimization/improvement system according to an example embodiment.

FIG. 2 is a block diagram illustrating a configuration of an optimization/improvement system according to an example embodiment.

FIG. 3 is a flowchart illustrating a method of operating a mobile device according to an example embodiment.

FIGS. 4 through 6 illustrate an example of an optimization/improvement scenario using a turnover gesture according to an example embodiment.

FIGS. 7 and 8 illustrate an example of an optimization/improvement scenario using a swipe gesture according to an example embodiment.

FIGS. 9 through 11 illustrate an example of an optimization/improvement scenario using a shake gesture according to an example embodiment.

FIG. 12 is a block diagram illustrating a configuration of a computer system according to an example embodiment.

### DETAILED DESCRIPTION

Example embodiments will now be described more fully with reference to the accompanying drawings, in which some example embodiments are shown. Example embodiments, may, however, be embodied in many different forms and should not be construed as being limited to the example embodiments set forth herein; rather, these example embodiments are provided so that this disclosure will be thorough and complete, and will fully convey the scope of the example embodiments to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “on,” “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Meanwhile, when it is possible to implement any example embodiment in any other way, a function or an operation specified in a specific block may be performed differently from a flow specified in a flowchart. For example, two consecutive blocks may actually perform the function or the operation simultaneously, and the two blocks may perform the function or the operation conversely according to a related operation or function.

Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, some example embodiments will be described with reference to accompanying drawings.

At least one example embodiment relates to a technology for improving and/or optimizing performance of mobile devices, and more particularly, to methods, systems, and/or non-transitory computer-readable mediums capable of improving and/or optimizing mobile devices using relatively simple and intuitive gestures.

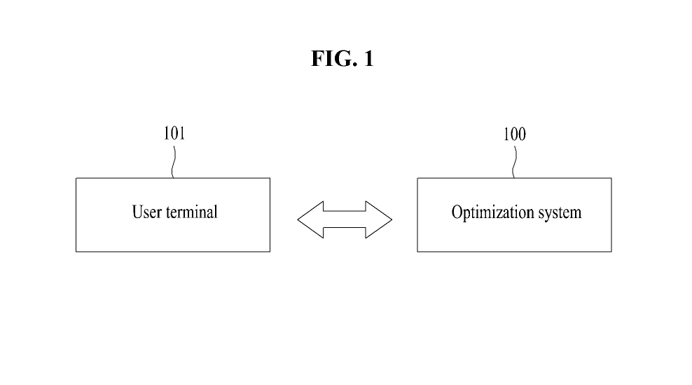

FIG. 1 is a diagram illustrating a relationship between a user terminal and an optimization/improvement system according to an example embodiment. FIG. 1 illustrates an optimization/improvement system 100 and a user terminal 101. In FIG. 1, an arrow indicator indicates that data may be transmitted and received, for example, over a wireless network or a data bus between the optimization/improvement system 100 and the user terminal 101.

The optimization/improvement system 100 may serve to provide an improvement and/or optimization function to maintain, for example, performance and/or load of the user terminal 101 in an optimal and/or improved state. In particular, for example, the optimization/improvement system 100 may improve and/or optimize functions of the user terminal 101 with relative ease and convenience in response to a relatively simple user gesture. The storage space of the user terminal 101 may be used as a storage configured to store a program code required for a basic system operation (e.g., an operating system (OS)) in an embedded memory form, and/or store, for example, photos, video, music, audio, documents, and/or other types of content. The user terminal 101 may experience performance degradation as available memory space decreases over time. Thus, an occupied memory space may be appropriately emptied to maintain the performance of the user terminal 101 in a more optimal state. Also, an amount of power used by a battery of the user terminal 101 may vary based on a utilization environment associated with various applications or modules (including, e.g., Bluetooth, a global positioning system (GPS), a wireless fidelity (Wi-Fi), and Long-Term Evolution (LTE), a display, etc.). Based on a specific utilization environment, an available utilization time of the user terminal 101 may be determined. Accordingly, the battery of the user terminal 101 may be managed to secure a utilization time by controlling the utilization environment of the user terminal 101 based on a situation. For example, the optimization/improvement system 100 may automatically perform improvement and/or optimization functions (e.g., memory cleaning, battery management, and/or application management) of the user terminal 101 in response to a user gesture on the user terminal 101. The optimization/improvement system 100 may be configured in the form of an application on the user terminal 101. Further, without being limited thereto, the optimization/improvement system 100 may be included in a service platform that provides improvement and/or optimization services in a client-server environment.

The user terminal 101 may be any type of terminal device (e.g., a smartphone, a tablet, a mobile device such as a wearable device, etc.), which is capable of installing and executing an exclusive application (hereinafter, an ‘optimization App’) associated with the optimization/improvement system 100. Here, the user terminal 101 may perform the overall service configuration (e.g., a service screen configuration, data input, data transmission and/or reception, data storage, etc.) under the control of the optimization App.

For example, the user terminal 101 may include a gesture recognition device that enables the user to input a desired (or alternatively, predefined) gesture as a user command for executing the optimization App. For example, a touch sensor may be used as the gesture recognition device. Using the touch sensor, a touch-based gesture (hereinafter, a ‘touch gesture’) may be input as a user command. In this example, the touch gesture may indicate a series of events occurring from a moment at which a touch occurs (e.g., the user contacts a screen of the user terminal 101) to a moment at which the touch is separated from the screen of the user terminal 101. In addition to a simple touch, the touch gesture may indicate any type of input by a touch operation, which includes, for example, a tap, flick, drag, swipe, pinch, etc. As another example, a non-contact sensor may be used as the gesture recognition device. Using the non-contact sensor, a motion of the user terminal 101 or a motion of an object over the user terminal 101, which is hereinafter referred to as a motion gesture, may be used to input a user command. In this example, a gesture by the motion of the user terminal 101 may be recognized as the user command by using, for example, a gyro sensor, an acceleration sensor, a geomagnetic sensor, a tilt sensor, etc., as the non-contact sensor. Also, a motion or an access of an object with respect to the user terminal 101 may be detected by using, for example, a motion recognition sensor or a proximity sensor as the non-contact sensor, and may be recognized as a motion gesture. Further, the motion gesture may include a hovering gesture, in which an object does not directly contact the screen of the user terminal 101. A hovering gesture-based technique refers to a technique for recognizing the proximity of an object (e.g., a finger) by detecting a change in capacitance when the finger is proximate to a capacitive touch screen. Although some example sensors and gestures are described above, example embodiments are not limited thereto and any type of touch gestures or motion gestures may be applied as a gesture for activating the optimization App.

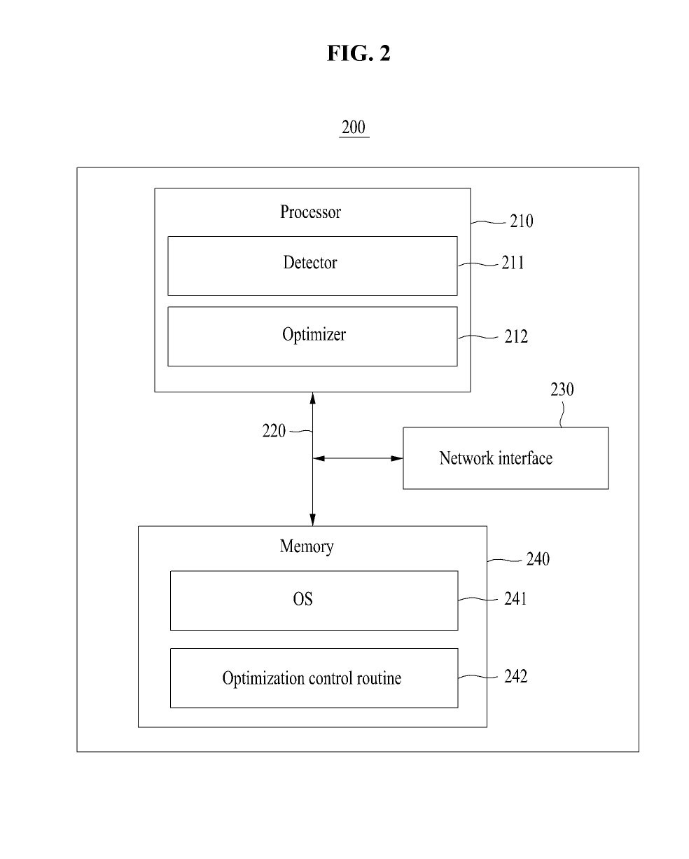

FIG. 2 is a block diagram illustrating a configuration of an optimization/improvement system according to an example embodiment.

Referring to FIG. 2, the optimization/improvement system 200 may include a processor 210, a bus 220, a network interface 230, and a memory 240. The memory 240 may include, for example, an OS 241 and an optimization and/or improvement control routine 242. The processor 210 may include, for example, a detector (or detector circuit) 211 and an optimizer (or optimizer circuit) 212. According to other example embodiments, the optimization/improvement system 200 may include additional constituent elements or some of the constituent elements may be omitted.

The memory 240 may include a mass storage device (e.g., a random access memory (RAM), a read only memory (ROM), a disc drive, etc.) as a computer-readable storage medium. Program code for the OS 241 and the optimization and/or improvement control routine 242 may be stored in the memory 240. At least a portion of the program code may be loaded from another computer-readable storage medium separate from the memory 240 using a drive mechanism (not shown). The another computer-readable storage medium may include, for example, a floppy drive, a disc, a tape, a DVD/CD-ROM drive, a memory card, etc. At least a portion of the program code may be loaded to the memory 240 through the network interface 230 instead of using the computer-readable storage medium.

The bus 220 may enable communication and data transmission between the constituent elements of the optimization/improvement system 200. The bus 220 may be configured to use a high-speed serial bus, a parallel bus, a storage area network (SAN), and/or another appropriate communication technology.

The network interface 230 may be a hardware element for connecting the optimization/improvement system 200 to the computer network. The network interface 230 may connect the optimization/improvement system 200 to the computer network through, for example, a wireless or wired connection.

The processor 210 may be configured to process computer-readable instructions of a computer program by performing a calculation, logic, and/or an input/output operation of the optimization/improvement system 200. The computer-readable instructions may be provided from the memory 240 or the network interface 230 to the processor 210 through the bus 220. The processor 210 may be configured to execute program code for the detector 211 and/or the optimizer 212. The program code may be stored in a storage device such as the memory 240. When executed by the processor 210, the computer-readable instructions associated with the detector 211 and the optimizer 212 may specially configure the processor to perform an optimization and/or improvement method, example embodiments of which are described in more detail below.

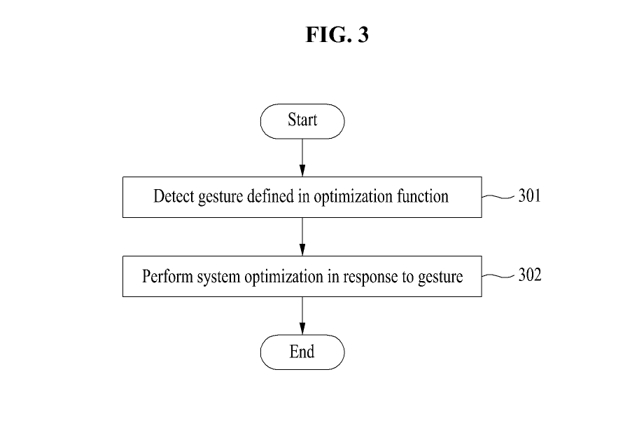

FIG. 3 is a flowchart illustrating an example of a method of operating a mobile device according to an example embodiment. Operations included in the example embodiment shown in FIG. 3 may be performed by the detector 211 and the optimizer 212 that are included in the optimization/improvement system 200 of FIG. 2.

Referring to FIG. 3, in operation 301, the detector 211 may detect a gesture on a mobile device as a user input. Here, the detector 211 may detect a predefined or desired gesture (hereinafter, an ‘optimization gesture’) among gestures recognized by a gesture recognition device (e.g., a touch sensor, a gyro sensor, etc.) of the mobile device. For example, the detector 211 may detect, as an optimization gesture, a turnover gesture in which a mobile device is turned over to make a screen of the mobile device face the floor. As another example, the detector 211 may detect, as an optimization gesture, a shake gesture in which a user shakes the mobile device. As still another example, the detector 211 may detect, as an optimization gesture, a swipe gesture in which one or more fingers move in a desired (or alternatively predetermined) direction (e.g., a horizontal or vertical direction), while one or more fingers touch a screen of a mobile device. As yet another example, the detector 211 may detect, as an optimization gesture, a rotation gesture of a mobile device in one axial direction among a roll axis direction, a pitch axis direction, and a yaw axis direction. As another example, the detector 211 may detect, as an optimization gesture, a midair gesture in which the user shakes an object without directly touching a screen of a mobile device, while putting the object relatively close to the screen of the mobile device. The optimization gestures mentioned above are merely examples, and thus, example embodiments are not limited thereto. Rather, any type of gestures in an intuitive input form with respect to an optimization/improvement function may be applied.

A motion gesture may be detected by a gesture recognition device such as a gyro sensor. In this example, the gesture recognition device may be active at all or substantially all times for an optimization and/or improvement operation. According to this example, however, when a user walks or runs with a mobile device in a pocket or a bag, such motion may be misrecognized as an optimization and/or improvement gesture, and this misrecognition may undesirably trigger an optimization and/or improvement function, thereby draining the battery. As a method of solving the aforementioned issues, the detector 211 may be set so that the gesture recognition device for detecting the optimization and/or improvement gesture does not trigger the optimization and/or improvement function when a person walks or runs, meaning that the gesture recognition device is set to be insensitive to the walking and running of the user, while being sensitive to the touch gesture and/or the motion gesture.

Still referring to FIG. 3, in operation 302, the optimizer 212 may recognize the optimization and/or improvement gesture as a user command for executing the optimization and/or improvement function, and may automatically perform a system optimization and/or improvement in response to the optimization and/or improvement gesture detected in operation 301. The optimization and/or improvement function may include a memory cleaning function, which appropriately empties a storage space to maintain the performance of the mobile device in an optimal and/or improved state, an application management function, which initializes a utilization environment of the mobile device at a rebooting level, and/or a battery management function, which decreases battery use of the mobile device and/or activates a power saving mode to reduce undesirable decrease of utilization time. In this example, the memory cleaning function may include an operation of deleting an arrangement target undesirably occupying the storage space of the mobile device. For example, the arrangement target may include a cache file, a temporary file, an application or content (e.g., photos, video, music, audio, documents, etc.) unused for a relatively long time (e.g., greater than a threshold period of time), and a file having a size greater than a threshold (or alternatively predetermined) size. The application management function may include an operation of deleting an inactive task and/or a background task from a memory to terminate a function and/or an application in execution. The battery management function may limit the maximum performance of central processing unit (CPU) in order to reduce an amount of power used by the mobile device. The battery management function may also include any type of operation for limiting a terminal utilization environment, which includes, for example, Bluetooth, Wi-Fi, a data network (e.g., LTE), GPS, screen brightness, an automatic synchronization, and a haptic feedback, etc.

The optimizer 212 may perform at least one optimization and/or improvement function among, for example, the memory cleaning function, the application management function, and the battery management function in response to the optimization and/or improvement gesture. For example, the same optimization and/or improvement gesture may be commonly defined with respect to optimization/improvement functions. For example, the optimizer 212 may perform all optimization and/or improvement operations corresponding to a plurality of functions, respectively, in response to the detected optimization and/or improvement gesture. As another example, a different optimization and/or improvement gesture may be defined for each optimization and/or improvement function. Accordingly, the optimizer 212 may selectively perform an optimization and/or improvement operation corresponding to an optimization and/or improvement gesture from among the plurality of optimization and/or improvement functions. According to at least some example embodiments, when the optimization and/or improvement gesture is repeatedly detected, the optimizer 212 may sequentially perform optimization and/or improvement functions. For example, in response to a repetitive optimization and/or improvement gesture, the optimizer 212 may perform the optimization and/or improvement operation in order of the memory cleaning function, the application management function, and the battery management function. When a desired (or alternatively, predetermined) function includes a plurality of stages, for example, when the battery management function includes a plurality of power saving stages, the optimizer 212 may sequentially perform the plurality of power saving stages stage by stage in response to the repeatedly detected optimization and/or improvement gestures. Further, when the function includes the plurality of stages, the optimizer 212 may sequentially perform the optimization and/or improvement operation stage by stage, or may skip a middle stage and perform the optimization and/or improvement operation corresponding to a final stage.

Hereinafter, an example optimization and/or improvement scenario in which the turnover gesture is set as the gesture that triggers an application management function, the swipe gesture is set as the gesture that triggers the memory cleaning function, and the shake gesture is set as the gesture that triggers the battery management function will be described. Matching between an optimization and/or improvement gesture and an optimization and/or improvement function is not limited to the above examples and may be variously modified.

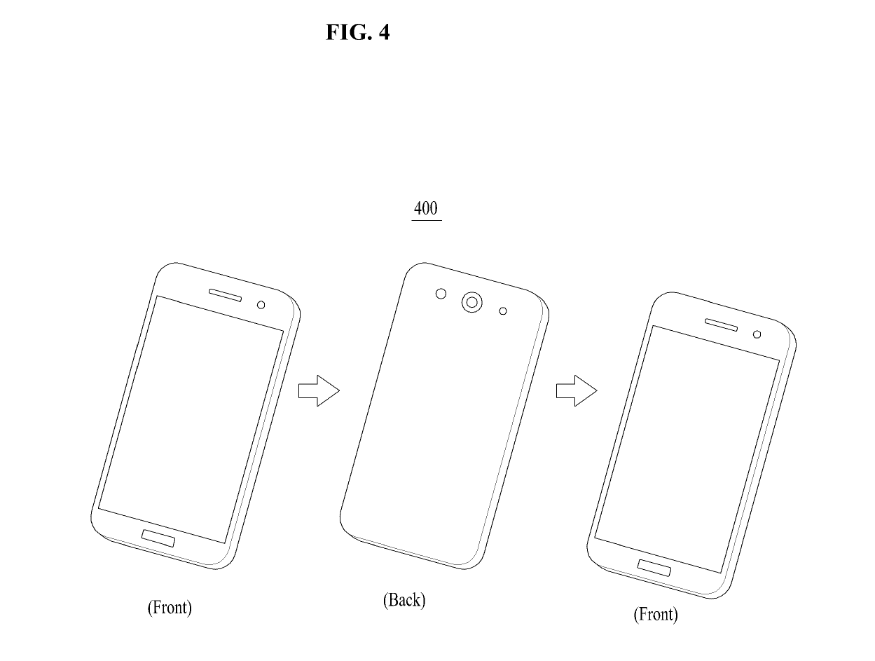

FIGS. 4 through 6 illustrate an example of an optimization and/or improvement scenario using a turnover gesture according to an example embodiment.

FIG. 4 illustrates an example of a turnover gesture 400. Referring to FIG. 4, the turnover gesture 400 may represent a motion of turning over a mobile device to make a screen of the mobile device face the floor. When a user experiences a delay of a utilization rate while using the mobile device, or wants to terminate all or substantially all applications in use, the user may perform a system optimization and/or improvement using the turnover gesture 400 as an optimization and/or improvement gesture.

In response to the detected turnover gesture 400, an optimization App may automatically perform an application management function for optimizing and/or improving the mobile device. When the user turns over the mobile device again, the user may perceive enhanced performance of the mobile device through an ongoing or completed optimization and/or improvement.

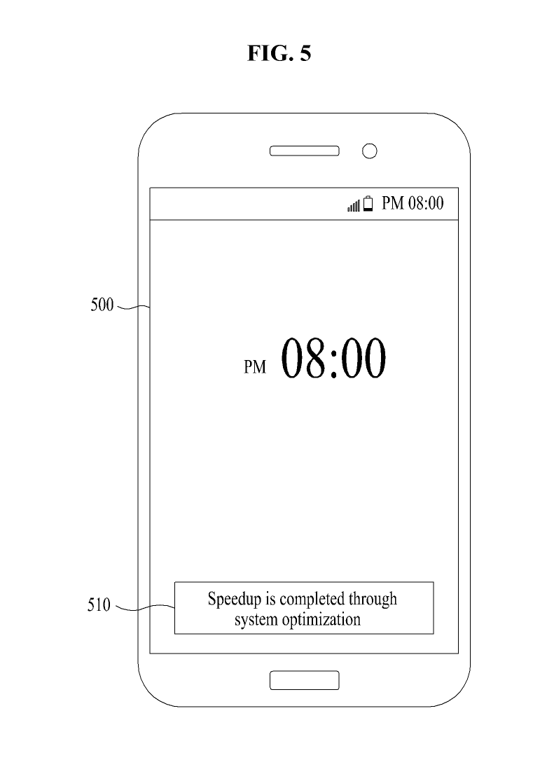

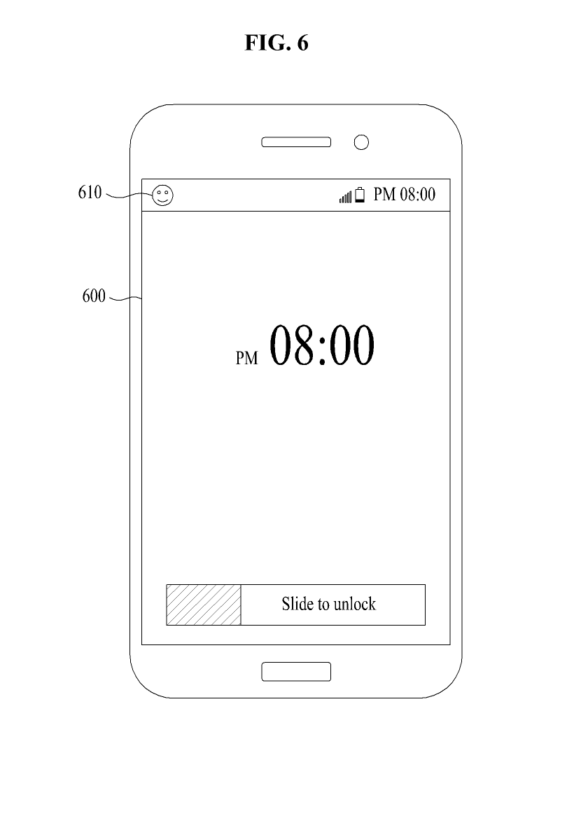

In this example, the optimization App may display a message 510 associated with an optimization and/or improvement state on a wallpaper 500 as illustrated in FIG. 5, or may display an icon 610 indicating that the optimization and/or improvement process is ongoing or completed on a task bar of a wallpaper 600 during a desired (or alternatively, predetermined) time, for example, about 10 seconds as illustrated in FIG. 6.

Accordingly, a utilization environment of the mobile device may be optimized and/or improved up to a rebooting level by automatically executing the optimization App in response to the turnover gesture on the mobile device and/or by deleting inactive or background tasks from the memory.

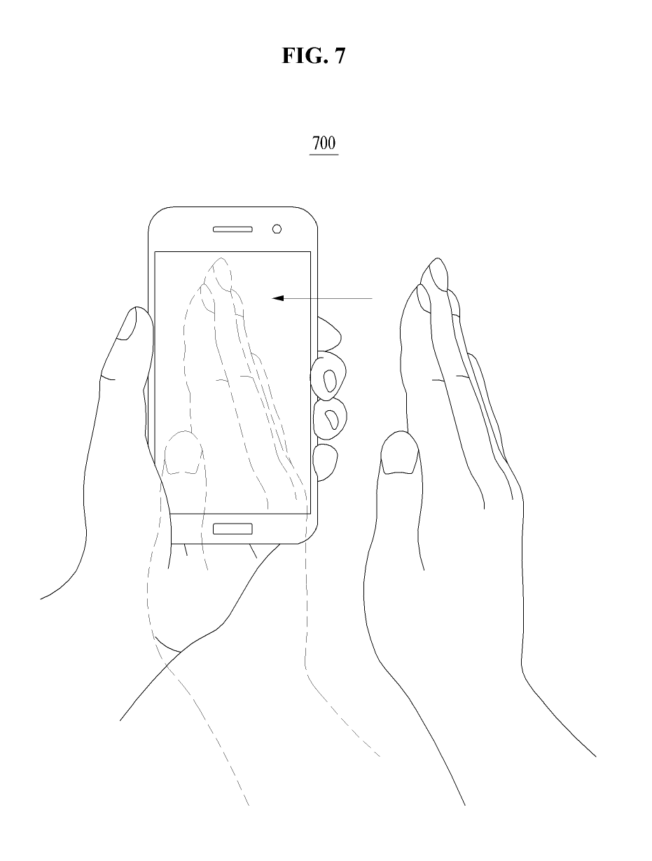

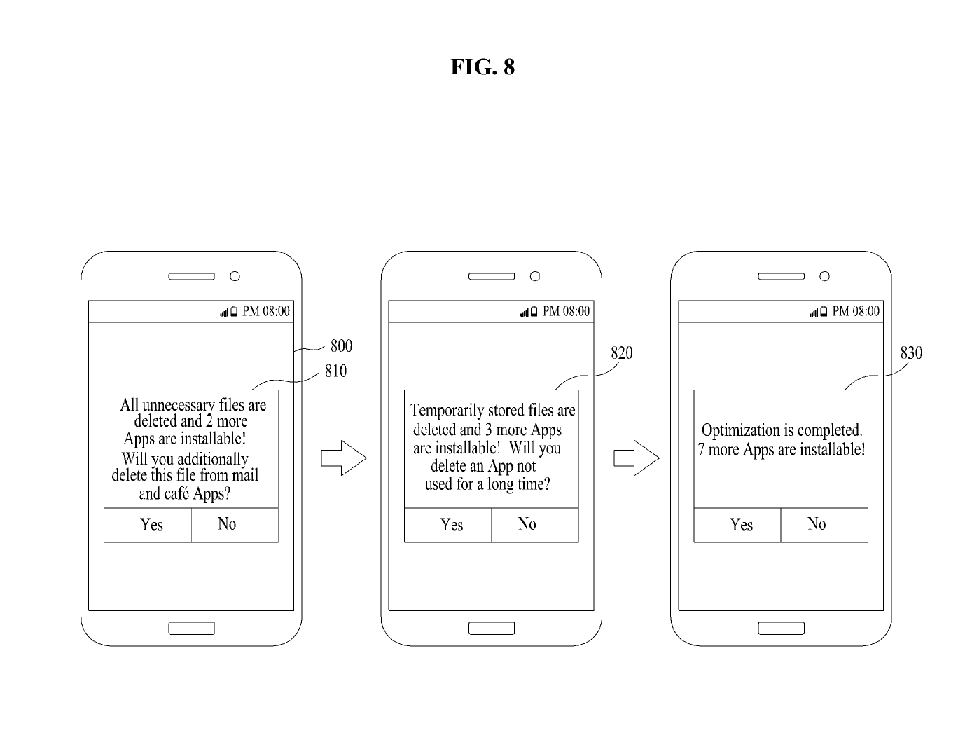

FIGS. 7 and 8 illustrate an example of an optimization and/or improvement scenario using a swipe gesture according to an example embodiment.

FIG. 7 illustrates an example of a swipe gesture 700. Referring to FIG. 7, the swipe gesture 700 may represent a motion of swiping one or more fingers from the right to the left on a screen of a mobile device. When a user experiences a delay of a utilization rate when using the mobile device, or when many files are undesirably stacked due to a lack of memory cleaning for a relatively long period of time, the user may request a system optimization and/or improvement in response to the swipe gesture 700 on the mobile device.

In response to the detected swipe gesture 700, an optimization App may automatically perform a memory cleaning function for optimizing and/or improving operation of the mobile device. Accordingly, the optimization App may improve and/or optimize a storage space of the mobile device by deleting arrangement targets undesirably occupying a memory.

In this example, the optimization App may classify targets to be arranged for a more efficient use of the memory based on each type, and perform (e.g., sequentially perform) an optimization and/or improvement for each target. For example, the targets to be arranged (e.g., cleaned) may be classified as a cache file (which includes a file, e.g., a thumbnail, created to more quickly call data when executing an application), a temporary file (which includes a duplicate of a file read by the user in, for example, e-mails or online café), and/or an unused application (which is unused for a threshold, or alternatively predetermined period, e.g., about 10, 20, or 30 days). For example, content (e.g., a photo, video, audio, and/or a document) unused for a threshold, or alternatively predetermined, period, content stored during a specific (or alternatively predetermined) period, and/or a file greater than a threshold, or alternatively predetermined, size (e.g., 100 Mb or more), may be classified as targets to be additionally cleaned.

The optimization App may sequentially delete targets to be arranged for a more efficient use of the memory in response to a repetitive swipe gesture for system optimization and/or improvement. For example, referring to FIG. 8, in response to a detected swipe gesture, the optimization App may perform a first-stage optimization and/or improvement by initially deleting a cache file and display a message 810 associated with a state of the first-stage optimization and/or improvement on a wallpaper 800. When the user repeats the swipe gesture or inputs an instruction, through a menu (not shown) provided together with the message 810 to delete a subsequent arrangement target, the optimization App may perform a second-stage optimization and/or improvement by deleting a temporary file and display a message 820 associated with a state of the second-stage optimization and/or improvement through a menu (not shown) provided together with the message 820. Once again, when the user repeats the swipe gesture or inputs an intent to delete a subsequent arrangement target through the menu provided together with the message 820, the optimization App may perform a third-stage optimization and/or improvement by deleting an application unused for a threshold (or alternatively, predetermined) period and display a message 830 associated with a state of the third-stage optimization and/or improvement.

Accordingly, the storage space of the mobile device may be optimized and/or improved by automatically executing the optimization App in response to the swipe gesture on the mobile device and by deleting, for example, the cache file, the temporary file, and/or the application unused during a relatively long period of time. Further, the optimization App may perform a memory cleaning arrangement function stage by stage by classifying an arrangement target for optimization and/or improvement and by repeating the swipe gesture.

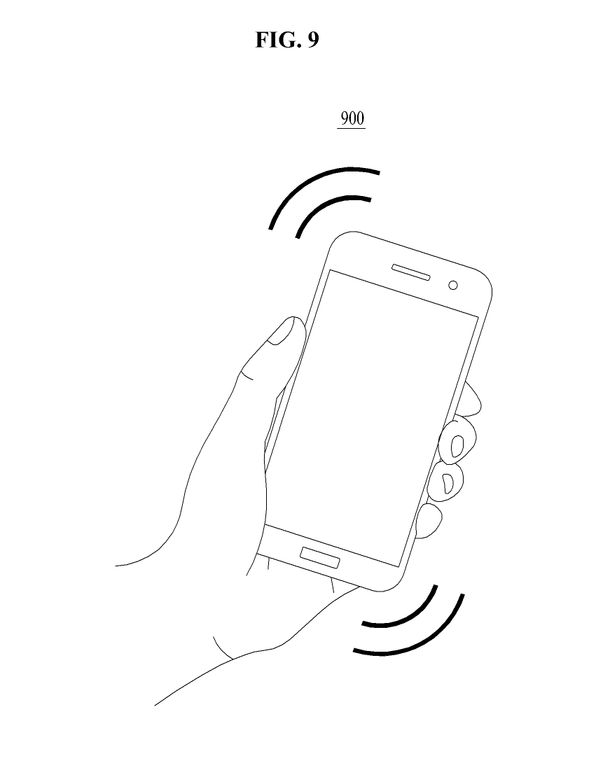

FIGS. 9 through 11 illustrate an example of an optimization and/or improvement scenario using a shake gesture according to an example embodiment.

FIG. 9 illustrates a shake gesture 900. Referring to FIG. 9, the shake gesture 900 may represent a motion of a user holding and shaking a mobile device. When a user is to extend a battery utilization time of the mobile device in a state in which a remaining battery amount of the mobile device is insufficient, the user may request a system optimization and/or improvement by using the shake gesture 900 on the mobile device.

In response to detecting the shake gesture 900, an optimization App may automatically perform a battery management function for optimizing and/or improving operation of the mobile device, thereby reducing battery utilization and extending a battery utilization time through a power saving mode.

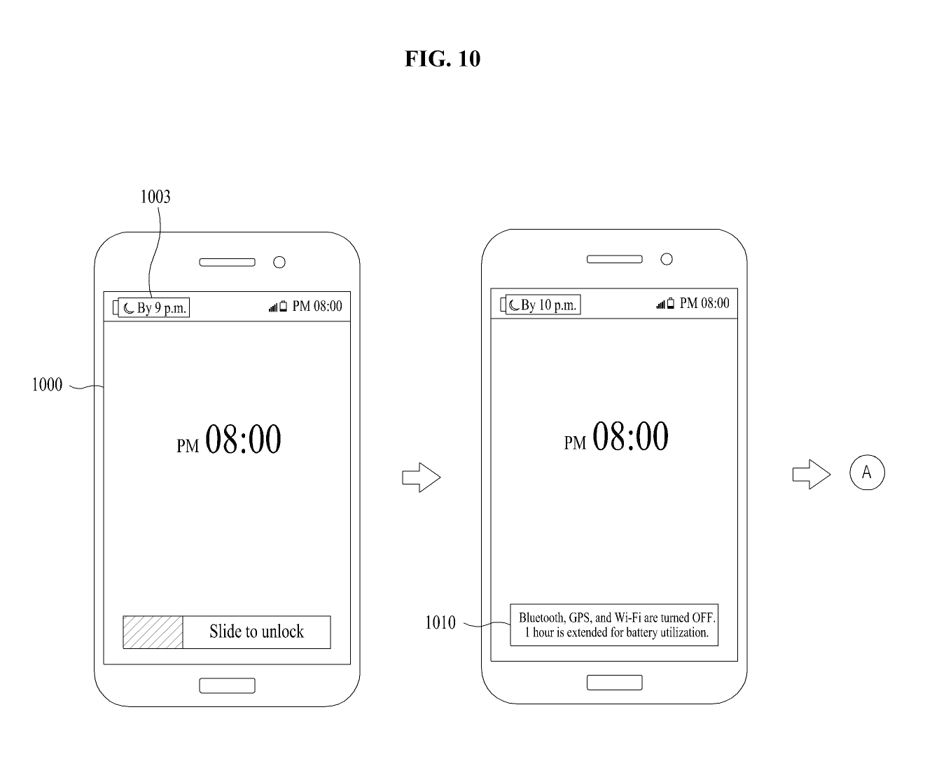

The optimization App may provide a remaining battery utilization time of the mobile device. For example, the optimization App may verify a remaining battery amount of the mobile device and/or a power consumption amount per unit time, may calculate the remaining battery amount into a time based on the verified information, and may display the remaining battery utilization time. Referring to FIG. 10, an optimization App may display a remaining battery utilization time 1003 corresponding to a remaining battery amount on a task bar of a wall-paper 1000. Accordingly, a user may check the remaining battery utilization time 1003 of the mobile device relatively easily, and may request optimization and/or improvement for battery management function based on the remaining battery utilization time 1003.

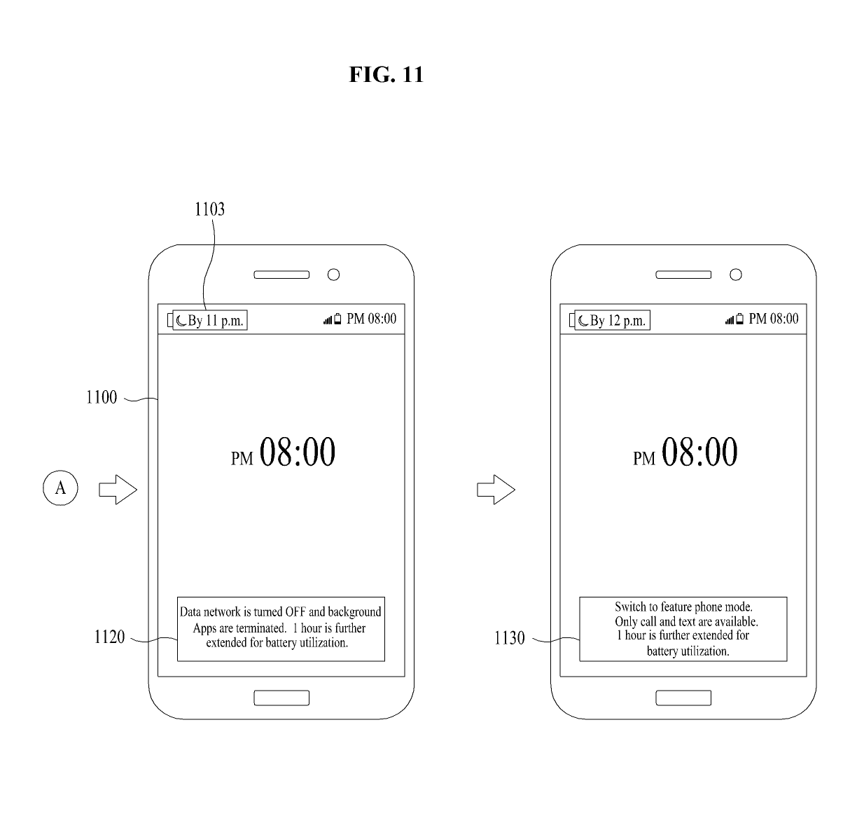

The optimization App may perform a power saving mode for battery management stage by stage. For example, referring to FIG. 10, in response to a detected shake gesture, the optimization App may automatically turn off, for example, Bluetooth, a GPS, and/or Wi-Fi of the mobile device as a first-stage power saving mode, and may display a message 1010 associated with the first-stage power saving mode. Here, the optimization App may recalculate a power consumption amount per unit time and a remaining battery life corresponding to a remaining battery amount increased through the first-stage power saving mode. Further, the optimization App may provide the recalculation result in the message 1010 and/or update a remaining battery utilization time displayed on a task bar. When the user repeats the shake gesture or inputs an instruction to proceed with a subsequent power saving stage through a menu (not shown) provided together with the message 1010, the application App may turn off a data network of the mobile device and terminate all or substantially all applications (e.g., turning off all or substantially all background Apps currently in execution using a second-stage power saving mode), and display a message 1120 associated with the second-stage power saving mode on a wallpaper 1100 as illustrated in FIG. 11. When the user repeats the shake gesture or inputs an instruction to proceed with a subsequent power saving stage through a menu (not shown) provided together with the message 1120, the optimization App may activate a feature phone mode as a third-stage power saving mode by turning off all functions except for a calling function and/or a texting function, and display a message 1130 associated with the third-stage power saving mode on the wallpaper 1100. The optimization App may recalculate a power consumption amount per unit time and a remaining battery utilization time corresponding to a remaining battery amount increased through a stage-by-stage power saving process, and provide the recalculation result in the messages 1120 and 1130 or update a remaining battery utilization time 1103 displayed on a task bar.

When the user inputs the shake gesture once again in a feature phone mode, the optimization App may restore a utilization environment of the mobile device to a state before the first-stage power saving mode is activated. Further, when a motion level of the shake gesture is less than a threshold level, the optimization App may sequentially perform a power saving mode in order of the first stage, the second stage, and the third stage. When the motion level of the shake gesture is greater than or equal to the threshold level, the optimization App may be immediately switched to a power saving mode of a final stage. For example, when the user strongly shakes the mobile device exceeding the threshold level in a situation in which the remaining battery amount is insufficient, the mobile device may be directly switched to the feature phone mode without going through a stage-by-stage power saving process.

Accordingly, a terminal utilization environment (e.g., Bluetooth, a GPS, Wi-Fi, a data network, and a background App) may be limited by automatically executing the optimization App in response to the shake gesture on the mobile device. Thus, a utilization time may be extended by reducing a battery utilization of the mobile device. Further, the power saving mode may be sequentially performed by dividing an optimization and/or improvement process for power saving into a plurality of stages and by repeating the shake gesture.

According to at least some example embodiments, a user may optimize and/or improve operation of the mobile device by activating, for example, an application management, a memory cleaning, and/or a battery management function, in response to an optimization and/or improvement gesture when using the mobile device, instead of searching for and executing an optimization and/or improvement application or manipulating a complex menu.

Service screens described with reference to FIGS. 4 through 11 are provided to help understanding of example embodiments and for clarity of description, and configurations or orders of the service screens as well as gesture methods and improvement and/or optimization operations may be modified.

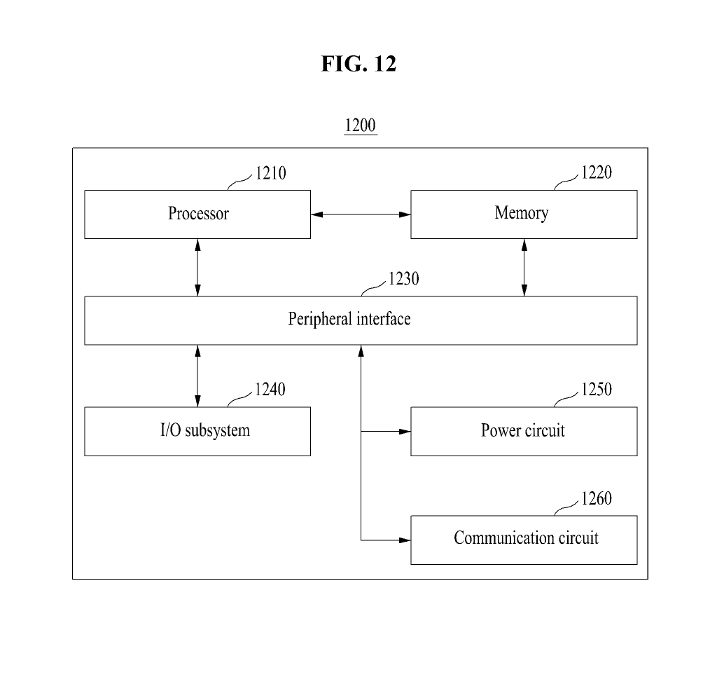

FIG. 12 is a block diagram illustrating an example configuration of a computer system 1200 according to an example embodiment.

Referring to FIG. 12, the computer system 1200 may include at least one processor 1210, a memory 1220, a peripheral interface 1230, an input/output (I/O) subsystem 1240, a power circuit 1250, and a communication circuit 1260. Here, the computer system 1200 may correspond to a user terminal.

The memory 1220 may include, for example, a high-speed random access memory (HSRAM), a magnetic disk, a static random access memory (SRAM), a dynamic RAM (DRAM), read only memory (ROM), a flash memory, a non-volatile memory, etc. The memory 1220 may store a software module, an instruction set, and/or a variety of data required for an operation of the computer system 1200. Here, an access of the memory 1220 from other component(s) (e.g., the processor 1210 and/or the peripheral interface 1230) may be controlled by the processor 1210.

The peripheral interface 1230 may couple an input device and/or output device of the computer system 1200 with the processor 1210 and/or the memory 1220. The processor 1210 may perform a variety of functions for the computer system 1200 and process data by executing the software module or the instruction set stored in the memory 1220.

The I/O subsystem 1240 may couple various I/O peripheral devices with the peripheral interface 1230. For example, the I/O subsystem 1240 may include a controller for coupling the peripheral interface 1230 with a peripheral device (e.g., a monitor, a keyboard, a mouse, a printer, a touch screen, a sensor, etc.). The I/O peripheral devices may be coupled with the peripheral interface 1230 without using the I/O subsystem 1240.

The power circuit 1250 may supply a power to all of or a portion of components of a terminal. For example, the power circuit 1250 may include a power management system, at least one power source (e.g., a battery and/or alternating circuit (AC)), a charge system, a power failure detection circuit, a power converter or inverter, a power status indicator, or other components for creating, managing and distributing power.

The communication circuit 1260 enables communication with another computer system using at least one external port. Alternatively, as described above, the communication circuit 1260 may enable communication with another computer system by using, for example, a radio frequency (RF) circuit, which is configured to transmit and receive an RF signal known as an electromagnetic signal.

The example embodiment shown in FIG. 12 is only an example of the computer system 1200. The computer system 1200 may have different configurations or different arrangements, by omitting a portion of the components illustrated in FIG. 12, by further including components not illustrated in FIG. 12, or by coupling two or more components. For example, a computer system for a communication terminal of a mobile environment may further include a touch screen, a sensor, and the like, in addition to the components of FIG. 12. A circuit for RF communication, which uses one of a variety of communication methods (e.g., wireless fidelity (Wi-Fi), 3rd generation (3G), long term evolution (LTE), Bluetooth, near field communication (NFC), ZigBee, etc.) may be included in the communication circuit 1260. Constituent components of the computer system 1200 may be configured as hardware that includes an integrated circuit specially designed for at least one signal processing or application, software, or a combination of hardware and software.

Methods according to one or more example embodiments may be implemented on or by the computer system 1200 shown in FIG. 12.

Methods according to one or more example embodiments may be configured in a program instruction form, which is executable through various computer systems, and may be recorded in non-transitory computer-readable mediums.

Programs according to one or more example embodiments may be configured as a PC-based program or an application exclusive for a mobile terminal. The optimization App according to the example embodiments may be configured in an independently operating program form, or may be configured in an in-app form of a desired (or alternatively predetermined) application that is operable on the application.

Also, the methods according to the example embodiments may be performed in such a manner that the optimization App controls the user terminal. The optimization App may be installed in the user terminal through a file provided from a file distribution system. As an example, the file distribution system may include a file transmitter (not shown) to transmit the file in response to a request from the user terminal.

As described above, according to at least some example embodiments, a user may automatically access an optimization and/or improvement environment using a relatively simple and intuitive gesture. Thus, a user may manage a mobile device more conveniently and/or easily. According to at least some example embodiments, a mobile device may be maintained in a more optimal state at all of substantially all times by automatically optimizing and/or improving operation of the mobile device in response to a user gesture. Thus, a user may perceive enhanced performance According to at least some example embodiments, a user may improve and/or optimize the mobile device by performing various functions (e.g., memory cleaning, a battery management, and/or an application management function), in response to a relatively simple gesture of the user, without searching for an optimization path or directly executing an application. Thus, user convenience may be enhanced.

The units and/or modules described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device(s) configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device(s) may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like. A processor may also be referred to as a processing circuit.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, and/or computer storage medium or device. The software also may be distributed over network coupled computer systems so that the software is stored and executed in a distributed fashion. The software and data may be stored by one or more computer readable recording media.

Methods according to the above-described example embodiments may be recorded in non-transitory computer-readable mediums including program instructions to implement various operations of the above-described example embodiments. The mediums may also include, alone or in combination with the program instructions, data files, data structures, and the like. The program instructions recorded on the mediums may be those specially designed and constructed for the purposes of some example embodiments, or they may be of the kind well-known and available to those having skill in the computer software arts. Examples of non-transitory computer-readable mediums include magnetic mediums such as hard disks, floppy disks, and magnetic tape; optical mediums such as CD ROM disks and DVD; magneto-optical mediums such as floptical disks; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

It should be understood that the example embodiments described herein should be considered in a descriptive sense only and not for purposes of limitation. Descriptions of features or aspects within each device or method according to the foregoing example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. A method of operating a mobile device, the method comprising:
detecting, by a processor, a gesture on the mobile device using a gesture recognition device of the mobile device; and
performing, by the processor, an improvement operation associated with at least one of a memory and a battery of the mobile device in response to the detected gesture.

2. The method of claim 1, wherein the detecting comprises:
detecting the gesture based on one of (i) a touch operation and (ii) a motion defined by a user command requesting improvement of the mobile device.

3. The method of claim 1, wherein the detecting comprises:
detecting, as a user command requesting the improvement operation, one of (i) a turnover gesture that turns over the mobile device, (ii) a swipe gesture that swipes a screen of the mobile device, and (iii) a shake gesture that shakes the mobile device.

4. The method of claim 1, wherein the improvement operation includes at least one of (i) a function of deleting at least one of an inactive task and a background task from the memory, (ii) a function of deleting, from the memory, at least one of a cache file, a temporary file, and an application unused for at least a threshold period, and (iii) a function of performing a power saving mode of the battery.

5. The method of claim 1, wherein the performing comprises:
deleting at least one of an inactive task and a background task from the memory in response to the detected gesture.

6. The method of claim 1, wherein the performing comprises:
deleting, from the memory in response to the detected gesture, at least one of a cache file, a temporary file, an application unused for at least a threshold period, content unused for at least the threshold period, and a file having a size greater than a threshold size.

7. The method of claim 1, wherein the performing comprises:
performing a power saving mode of the battery in response to the detected gesture.

8. The method of claim 7, wherein, in the power saving mode, at least one of a communication module, a background application, screen brightness, automatic synchronization, and haptic feedback of the mobile device is limited.

9. The method of claim 1, wherein the performing comprises:
performing the improvement operation stage by stage in response to repeated detection of the gesture; and
wherein the improvement operation includes a plurality of stages.

10. The method of claim 9, wherein the performing the improvement operation stage by stage comprises:
skipping a middle stage of the improvement operation and performing a final stage of the improvement operation in response to a level of the detected gesture being greater than or equal to a threshold level.

11. A non-transitory computer-readable medium including computer-readable instructions that, when executed by a processor, control the processor to perform a method comprising:
detecting a gesture on a mobile device using a gesture recognition device of the mobile device; and
performing an improvement operation associated with at least one of a memory and a battery of the mobile device in response to the detected gesture.

12. A system comprising:
a processor including,
a detector configured to detect a gesture on a mobile device using a gesture recognition device of the mobile device, and
an optimizer configured to perform an improvement operation associated with at least one of a memory and a battery of the mobile device in response to the detected gesture.

13. The system of claim 12, wherein the detector is further configured to detect, as a user command requesting the improvement operation, one of (i) a turnover gesture that turns over the mobile device, (ii) a swipe gesture that swipes a screen of the mobile device, and (iii) a shake gesture that shakes the mobile device.

14. The system of claim 12, wherein the improvement operation includes at least one of (i) deleting at least one of an inactive task and a background task from the memory, (ii) deleting, from the memory, at least one of a cache file, a temporary file, and an application unused for at least a threshold period, and (iii) a function of performing a power saving mode of the battery.

15. The system of claim 12, wherein the optimizer is configured to delete at least one of an inactive task and a background task from the memory in response to the detected gesture.

16. The system of claim 12, wherein the optimizer is configured to delete, from the memory in response to the detected gesture, at least one of a cache file, a temporary file, and an application unused for at least a threshold period, content unused for at least the threshold period, and a file having a size greater than a threshold size.

17. The improvement system of claim 12, wherein the optimizer is further configured to perform a power saving mode of the battery in response to the detected gesture.

18. The improvement system of claim 17, wherein, in the power saving mode, at least one of a communication module, a background application, screen brightness, automatic synchronization, and haptic feedback of the mobile device is limited.

19. The improvement system of claim 12, wherein when the improvement operation includes a plurality of stages, the optimizer is configured to perform the improvement operation stage by stage in response to repeated detection of the gesture.

20. The improvement system of claim 19, wherein the optimizer is configured to skip a middle stage of the optimization operation and perform a final stage of the optimization operation in response to a level of the detected gesture being greater than or equal to a threshold level.
